(19) United States
(12) Patent Application Publication
(10) Pub. No.: US 2009/0204539 A1
(43) Pub. Date: Aug. 13, 2009

(54) Portable Electronic Financial Management

(76) Inventor: Andre Parker, North Miami Beach, FL (US)

Correspondence Address: Allen F. Bennett;Santucci, Priore & Long, LLP, 200 South Andrews, SUITE 100, FORT LAUDERDALE, FL, 33301, US

(21) Appl. No.: 12/030,245

(22) Filed: Feb. 13, 2008

(51) Int. Cl. G06Q 20/00

(52) U.S. Cl. 705/41; 705/44

(57) ABSTRACT

An electronic wallet stores information regarding credit, membership and other accounts. The information may be accessed to facilitate monetary and other transactions utilizing the various stored accounts. The transactions are stored such that accurate account balances are maintained by the electronic wallet. Security measures prevent unauthorized users from accessing account information. The electronic wallet allows a user to program preset spending limits on the accounts stored in it. The electronic wallet includes a protective carrying case having a money clip and card holding slots.

### CROSS-REFERENCE TO RELATED APPLICATIONS

None

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT DISC APPENDIX

None

### BACKGROUND OF THE INVENTION

1. Field of the Invention

The present invention relates to a portable device and method for assisting an operator in accurately recording and managing expenditures. Specifically, the invention provides a portable device for securely storing credit account information and tracking activity on credit accounts.

2. Prior Art

Financial institutions and commercial companies issue credit and debit cards typically carried in a wallet in addition to a variety of other types of cards including frequent flyer cards, video club cards, library cards, insurance cards and a driver's license. Typically, consumers carry numerous cards and accept the inconvenience of bulging wallets.

Even ignoring the annoyance of carrying multiple cards and finding the right card when needed, problem remain. A consumer exposes himself or herself to the risk of loss or theft and identity theft. Canceling and replacing lost or stolen credit cards, debit cards and membership cards can create substantial stress for the cardholder. Unauthorized use of a stolen card before cancellation may further exacerbate the stress a cardholder experiences.

Commercial institutions have developed various techniques aimed at reducing fraudulent transactions, such as the ubiquitous Personal Identification Number (PIN) systems. While PIN systems may partially reduce fraudulent purchases for debit cards, the application of this system does not cover the broad area of retail purchases. Many charge cards and credit cards only require the PIN when using an ATM. This poses a security risk to the cardholder because anyone with a lost or stolen card can charge purchases to the card account.

A more recent solution to the security issue is the smart card. U.S. Pat. No. 6,954,133 B2 to McGregor et al. provides a smart card having a biometric security device and/or PIN security feature. This approach supposedly provides merchants more information when deciding if the consumer is the cardholder. Like the PIN system, smart cards partially address the security issue aimed at reducing fraudulent purchases. However, they do not simplify a person's money management.

U.S. Pat. No. 7,155,411 B1 to Blinn et al. provides a means to make all of a user's credit and other accounts available through a central network. A single electronic device stores and may transmit identifying data for all of a user's credit and other accounts. However, this invention requires card issuers, card holders and vendors to all connect to a central network and does not address a person's money management needs.

The Blinn invention eliminates the need to carry multiple credit or other cards. However, it adds the security of risk of a broad network over the internet. It also requires an extensive internet network and all parties to the transaction to be within the network. It does not provide any means for a user to adequately monitor the amount of money being spent in real-time. The invention actually encourages spending by automatically providing every payment method available to every vendor, so that if one account has insufficient funds, the difference may applied to an alternative account.

U.S. Pat. No. 5,748,737 to Daggar provides an electronic wallet and an accompanying generic card onto which the information for various cards may be recorded. The electronic wallet reads and writes on one or more magnetic strips of the generic card to allow ready interface with magnetic strip readers. The invention also functions as a remote, portable point-of-sale device. This patent describes another method for using a single card in place of several cards.

The prior art discloses several methods of ameliorating the difficulties of maintaining and protecting several different cards, including credit cards, discount cards gift certificate cards, phone cards, membership cards and the like. Various efforts have been made to consolidate various identification and credit sources as well as ease the process of performing a financial transaction. However, the increasing ease of financial transactions has increased the frequency of impulse buying and other habits consumers are susceptible to that complicate proper and responsible management of finances. For example, when the invention disclosed in the Blinn patent is utilized, a consumer may continue spending until all of his or her financial resources are entirely exhausted. Such a system hinders responsible money management.

Financial irresponsibility is systemic in the Western World, especially the United States. Recent changes in the law, such as the revised bankruptcy code may alleviate some of the symptoms. However, the rising per capita revolving and other debt of the population is best cured by better consumer money management, preferably while maintaining ease and convenience of monetary transactions.

Presently, a consumer must organize receipts and sort them according to which credit line was used for each expenditure. This task is time consuming and often disregarded. All of these transactions must then be reconciled and consolidated. Furthermore, multiple users often utilize the same credit lines, further complicating the accurate monitoring of transactions. Consumers often intend to carefully monitor and budget their money but are overcome by the impracticality of doing so.

It is therefore desirable to provide a secure system for consolidating several different cards, including credit cards, discount cards, gift certificate cards, phone cards, membership cards and the like into a single, secure source.

It is also desirable to provide a secure system for consolidating several different cards, including credit cards, discount cards gift certificate cards, phone cards, membership cards and the like into a single, secure source that allows a consumer to responsibly monitor and regulate transactions and expenditures.

### BRIEF SUMMARY OF THE INVENTION

The present invention provides an electronic wallet that stores information for multiple cards and storing information typically carried in a wallet individually. The invention uses security measures to prevent access by unauthorized users to the information stored. The invention also creates a real-time log of all purchases made using individual credit and other cards. This log of purchases is organized by the invention such that a user may readily access transaction registers and histories for each credit line. The invention also provides a means for setting a limit on the amounts that may be applied to each credit line available. This information may be transferred to a computer or other device having budgeting or other software. This allows a consumer to track and record transactions in real-time so that spending limits may be enforced

The invention also allows the user to pre-set spending limits on different credit accounts stored in the electronic wallet. This allows the user to regulate and restrict transactions conducted with the electronic wallet.

It is therefore an object of the invention to provide an electronic wallet and method for storing information for multiple lines of credit in a single portable device.

It is therefore a further object of the invention to provide an electronic wallet and method for storing information for multiple lines of credit in a single device that allows the user to monitor and regulate the transactions conducted using the electronic wallet.

### BRIEF DESCRIPTION OF THE DRAWINGS

FIG. 1 is a perspective view of a preferred embodiment of the invention.

FIG. 2 is an alternate perspective view of a preferred embodiment of the invention.

FIG. 3 is an alternate perspective view of a preferred embodiment of the invention.

FIG. 4 is an alternate perspective view of a preferred embodiment of the invention including a protective case.

FIG. 5 is a flowchart of a method of a preferred embodiment of the invention.

FIG. 6 is a flowchart of a method of a preferred embodiment of the invention.

### DETAILED DESCRIPTION OF THE INVENTION

The present invention is provided in order to assist consumers in the organization, management and accurate tracking of their usage of credit cards. The invention is an electronic device, referred to herein as an electronic wallet that stores all information required for all of a particular consumer's credit cards, membership cards, gift cards and the like. Security features prevent unauthorized users from gaining access to this information. The invention has a slot along its bottom capable of registering and reading a magnetic strip on a credit card. Credit card information may be entered into the electronic wallet using this slot. Credit card information may also be entered and retrieved using a USB port located on the electronic wallet. A touch screen and stylus of the electronic wallet allows a user to manipulate and enter information and enter commands into the electronic wallet. Also included is a jack for recharging the wallet's battery found in its battery case. A small speaker is also optionally included to provide audio messages. Similarly, a microphone may be optionally included. Information from the electronic wallet is accessed, viewed and retrieved by means of the USB port, the touch screen or a radio frequency or other electromagnetic receiving/transmitting device. The electronic wallet includes a protective case that preferably has slots for holding cards and a low profile money clip. These combined features allow a consumer to replace a common wallet with the invention. The electronic wallet makes identity theft substantially more difficult.

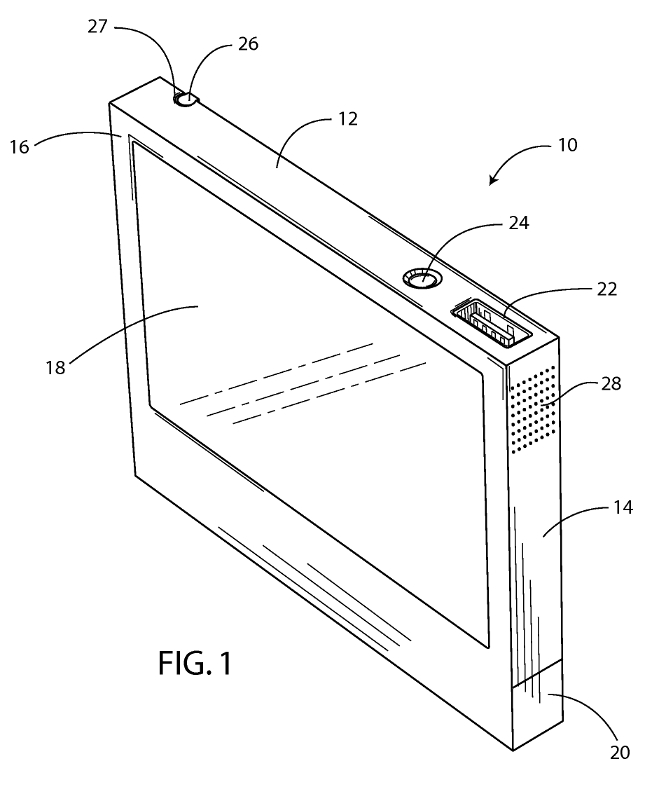

FIG. 1 shows a perspective view of the electronic wallet. Wallet 10 has a front surface 16 with a touch screen 18. Touch screen 18 is used to operate the wallet. Stylus 26 is contained within stylist slot 27. Stylist 26 is used to manipulate touch screen 18. Stylist slot 27 is on the top surface 12 of the wallet 10. Also located on top surface 12 are USB port 22 and recharging jack 24. Recharging jack 24 is attachable to a recharger, not shown, that provides power so that an internal battery of wallet 10 may be recharged. USB port 22 allows wallet 10 to be electronically attached to a computer, a point-of-sale device or other electronic device. Side panel 14 of wallet 10 includes a speaker 28. Speaker 28 may be used to emit audio alerts and notices. Slot cover 20 is removably attached to the bottom of wallet 10. USB port 22, jack 24, stylus slot 27 and speaker 28 may be located at any convenient place on the electronic wallet. Those skilled in the art will appreciate that the configuration shown in FIG. 1 is only one of many possible alternatives that will not significantly affect the utility of the invention. Those skilled in the art will also appreciate that it may be desirable to include a keypad on the invention. It may also be preferable to include a biometric device for reading fingerprints or other identifying features of the user.

An RF or other electromagnetic wave transceiver is also optionally included for transferring information wirelessly to a computer, point of sale or other device.

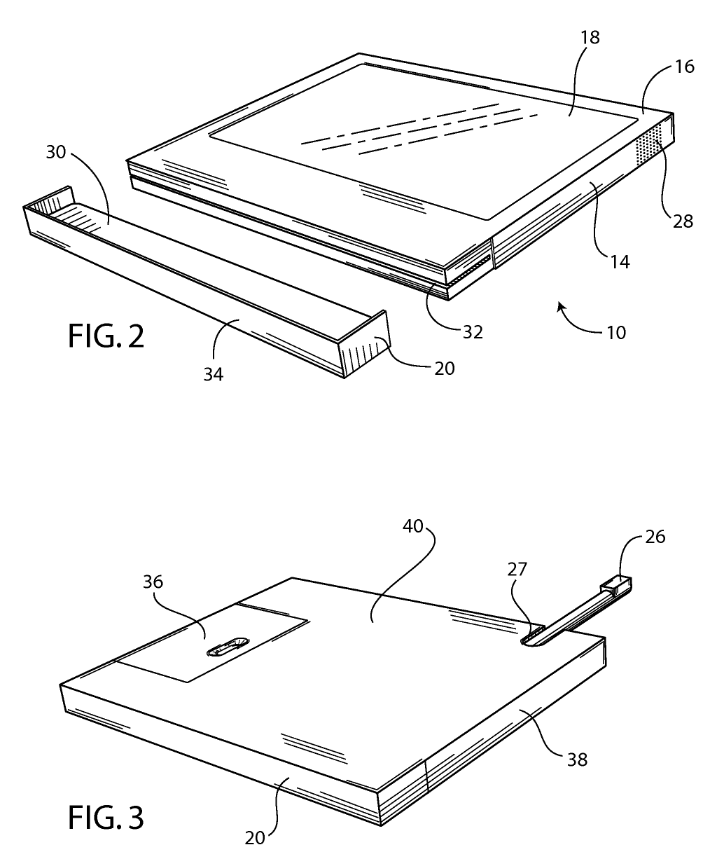

FIG. 2 shows a perspective view of wallet 10 with slot cover 20 disengaged from wallet 10. Slot cover 20 is comprised of a bottom panel 34 and a card slot insert 30. Insert 30 is an optional feature of cover 20. When attached to wallet 10, slot insert 30 of cover 20 fits within card slot 32. Card slot 32 is designed such that the magnetic strip of a plastic credit card may be run through it. Card slot 32 includes within it a means for reading a magnetic strip.

FIG. 3 is a perspective view of wallet 10 showing rear panel 40. Second side panel 38 may also be seen. Rear panel 40 includes battery compartment 36. Battery compartment 36 is designed to store a rechargeable battery to power the wallet 10.

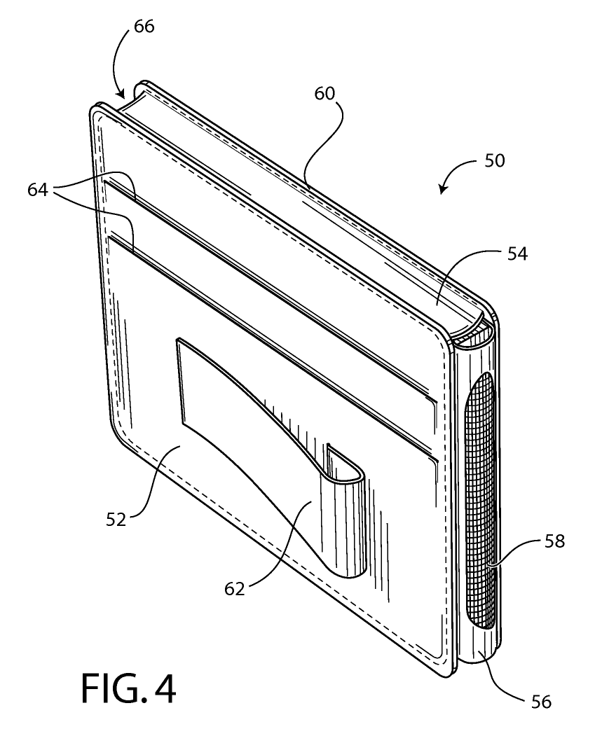

FIG. 4 shows a perspective view of wallet case 50 surrounding wallet 10. Wallet case 50 has a front 52 and a back 60. Case 50 is preferably made from a soft, durable leather or similar material. A flexible bottom 56 allows a user to push the wallet within the case out of opening 66. Bottom 56 optionally includes a mesh vent 58. Elastic side 54 allows a wallet to fit snuggly with case 50. The second elastic side is not seen in this view of the case 50. Those skilled in the art will appreciate that this is only one of many possible designs for a convenient wallet case.

Front 52 includes a low profile money clip 62. While use of paper money has become less common as consumers increasingly use credit cards for transactions, it is often still desirable to carry some cash. The low profile money clip allows cash to be carried without substantially increasing the bulk of the wallet and case. Front side 52 also includes two card pockets 64. In this embodiment, two card pockets are included. However, it may be desirable to have additional card pockets or none at all. Some cards are temporary, making them impractical for use with an electronic wallet. Other cards are preferably carried in person, rather than electronically, such as a driver's license. It may also be desirable to provide room for business cards or the like.

The wallet and case shown in the embodiment of FIGS. 1-4 illustrate many of the desirable features of an electronic wallet. However, additional features, such as a microphone, a coaxial cable port, other data transmission ports, a laser scanner or the like may also be included.

A user of the wallet can enter the information of a credit card by swiping it through the slot on the wallet. The wallet reads the information encoded in the magnetic strip and stores that information in its memory. The user may verify the card type, number and security code located on the back of the card. The user may store the card in the wallet's memory under a nickname or other means of reference. Information for multiple cards may be stored in the electronic wallet. Typically, a user will store information regarding credit cards. However, other account information may be stored. For example, membership cards commonly have a magnetic strip for identification. This card may be swiped into the wallet and the information recorded under a nickname chosen by the user. Typically the nickname will make reference to the type of card stored. Discount cards may also be similarly stored. For example, it is common for large bookstore chains to offer cards granting the owner a percentage discount off purchases. Such discount cards are available for an annual fee. Such a card may be swiped into the wallet and stored under the name of the store for which it is used. Gift certificates may also be similarly stored in the wallet. It is also possible to download membership, credit and other account information by means of a computer or other electronic device.

The electronic wallet may be connected to a computer or other device by means of a USB port. In this manner, identifying information for some or all of a consumer's credit cards, bank accounts, gift certificates, membership discounts and the like may be transferred to or from the device. For each account, the user may enter a starting balance and any other desired information. Transactions are recorded and applied to the balance. In this manner, the electronic wallet serves as a check register and an automatic account balancer for all of the accounts entered into the device. Important dates and other information may also be entered in regard to each account. The electronic wallet provides the option of activating an alert at certain preset times in order to inform the user that a payment or other deadline is approaching. For example, a due date for a membership card having an annual fee may be recorded in the electronic wallet. The user can then program the electronic wallet to provide a reminder notice at a predetermined time prior to the due date. The reminder notice may be displayed on the video screen or may be an audio recording or other sound.

The user can optionally set daily, monthly or other transaction limits. A user may decide to go shopping for several items. For example, a user may decide to go Christmas shopping for his or her entire family. It may be desirable to limit the amount of money spent on a particular shopping excursion. The user may set a total amount of money he will allow himself to spend on that day. The user may set individual spending limits for each credit line or, alternatively, may set a spending limit as a total for all accounts combined. The electronic wallet tracks all expenditures as part of its registering function. The electronic wallet allows the spending limits to optionally be set by a person other than the user, such that one person may set spending limits for another person who is the actual user of the electronic wallet. This may be desirable for a parent who wishes to allow a child to make limited purchases.

Spending limits may also be set according to the type of purchase made. In the above example, a user may wish to spend a set amount on each person on his or her Christmas list. The invention may be used to track the transactions and total spent per individual. The expenditures analysis programming of the invention allows a user to monitor the total transactions for any parameter, characteristic or other property.

It is often recommended that when gambling a person enter a casino with a certain amount of money and not withdraw more if he runs out. This invention allows a user to limit himself or herself as to the amount of amount of money that may be spent within a given time period.

Another benefit of the registering and tracking capabilities of the invention are to avoid unwanted over the limit fees typically charged by credit cards and other accounts. When a credit card is used several times in a relatively short time period, the user may inadvertently exceed the credit limit allowed on that account. This is due to the speed of use of a credit card exceeding the speed with which transactions can be registered by the card issuer. Credit card transactions are often approved only because all transactions have not been fully recorded by the card issuer. This results in the consumer spending more than the card has authorized. By tracking all amounts spent in real time, the electronic wallet of the invention prevents these errors.

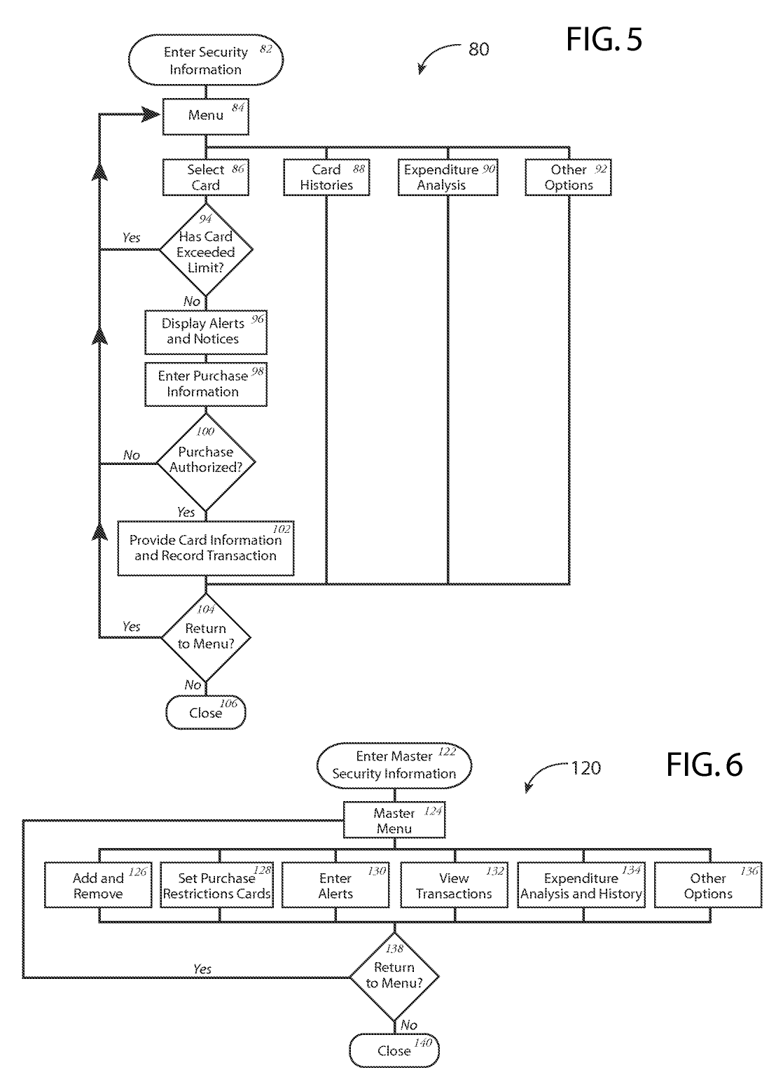

Once credit card and other information alerts and/or limits have been entered into the electronic wallet, it is ready to be used. The preferred method for using the invention is described below and in FIGS. 5 and 6.

When operated, the invention requires that a security password and/or other information is entered to verify that the user is an authorized user of the device. The user then enters the transaction properties into the device. These transaction properties include which credit account the transaction is to be applied to and the amount of the transaction. The transaction properties may also include the time and date (which may be automatically entered by a timekeeping program running on the device), the vendor, the item(s) being purchased, for whom a purchase is being made (as in the Christmas list example above) or other information. If the purchase will not exceed either the funds available or the self-set spending limit, the invention approves the transaction. The invention then provides the information needed to conduct the transaction, such as a credit card account number, expiration date and security code. The information may be provided by any of the output components of the device including a video screen, a USB port electromagnetic transmission, audio speaker or the like. The invention then records the transaction and adjusts the available balance and any self-set spending limit accordingly. In this manner, the invention maintains a real time account balance.

The invention may also function as a scheduler and notepad. Information such as membership card information, important dates such as birthdays and due dates for various items may be recorded in the device and alerts may be set to notify the user of the dates either on the date or a chosen time beforehand.

The invention may have a master user having a master security code. The master user may add or remove credit or other account information and set spending limits. The invention may have other users that only have access to the information stored in the device but not allow the other users to modify pre-set spending limits. In this manner, a parent may allow a child to temporarily use the invention without allowing the child to make unauthorized purchases. For example, a parent may pre-set a certain dollar amount spending limit and a list of authorized vendors and allow a child to use the device to purchase clothing. The child would be prevented from spending more than the parent allotted and would be unable to make purchases at unauthorized locations. For example the authorized user list could include stores having reasonably priced clothing so that the child could not spend too much money on too few items.

FIG. 5 illustrates a flowchart showing a typical use of a preferred embodiment of the electronic wallet. When a user desires to make a transaction, security information is inputted 82 into the electronic wallet. This is commonly done by entering a preset password or code and/or answering one or more security questions. This code may be entered using any input component on the invention including a radio frequency or other electromagnetic transmission, the USB port, a touch screen, a keypad, a fingerprint reading or other biometric device or the like.

Once security information has been properly entered 82, the user is provided with a menu 84 that includes several options. These options may include reviewing credit account histories 88 in which the user may review the starting balance, preset limits and transactions conducted on various credit accounts stored within the card.

The menu 84 may also provide expenditure analysis options 90, displaying a review of transactions grouped and/or totaled according to transactions type, vendor identification or type, date, amount and/or location. This allows a user to monitor the types of transactions made as well as where and to which vendors they were made. Those skilled in the art will appreciate that this is similar to many types of expenditure analyses available in computer software, on credit card internet websites, and other locations.

Other options 92 are also preferably available through menu 84. These other options may include a notepad that may be used to record shopping lists, important dates and may serve as a scheduler. These other options 92 may also include important information such as birth dates, addresses, emails and phone numbers.

The menu 84 also provides the user with the option of selecting a credit account to use for a transaction 86. This feature allows the user to choose one of the accounts stored in the electronic wallet to make a purchase. Once an account is selected 86, the electronic wallet determines whether that account has reached its limit 94. If the limit has been reached, access to the information for that account is not allowed and the electronic wallet returns to the menu. This step may be incorporated into step 100 below.

If the limit has not been reached for the selected card, then the electronic wallet determines whether any alerts or notices apply to the account selected. If there are any notices appropriate, such as an alert that the selected account is close to its limit, the notice or alert is displayed 96. The user is given the option to return to the menu. This step may also be incorporated into step 100.

After any alerts and notices have been displayed 96, the user may enter transaction information, i.e. the properties of the transaction into the electronic wallet 98. These properties include the amount of the transaction and the credit account selected. Optionally the properties may include other information including the location, the vendor, for whom the purchase is made, the time and date, and the like. These properties may be entered by means of the touch screen, a key pad, the USB port, radio frequency or other electromagnetic means or any other appropriate means.

Once the transaction properties are entered 98, the electronic wallet verifies that the purchase is authorized 100. In this step, the electronic wallet compares the transaction properties entered in step 98 with stored preset limits. The electronic wallet verifies that the transaction amount does not exceed the limit set for the account chosen, that the vendor is not unauthorized and/or that any other preset limits regarding any of the properties of the transaction are not violated by the transaction. If the transaction violates any of the preset limits, then the transaction will not be allowed. If the transaction is allowable, the electronic wallet provides the account information 102 by any of several means including visual display on a touch or other screen, radio frequency or other electromagnetic emission, a USB port or the like.

Once the transaction is performed, the electronic wallet records and stores the transaction, updating the balance on the account used. The transaction properties stored may also be used by the electronic wallet to update the account histories, expenditure analyses and other information stored. The wallet then offers the user the options of returning to the menu or closing and shutting down the electronic wallet 104. If the user determines that he or she has completed the transaction and observing the data stored by the device, the close option will be selected and the device will shut down 106. This process may be repeated.

FIG. 6 shows a flowchart of a preferred means for storing master information and limitations on the electronic wallet 120. Master security information is first entered 122 into the electronic wallet. Preferably, the master security information is different from the security information entered in step 82 above. When the master security information is entered into the electronic wallet, additional functions are allowed by the master menu 124.

The master menu 124 offers some of the same features found on the regular menu 84 above. Expenditure analyses and histories 134 may be viewed. Other options 136 including a notepad and other features may also be accessed. Transaction histories 132 may also be viewed.

Master menu 124 also offers additional options. The user with access to the master menu may add or remove credit account information 126 from the electronic wallet. This allows the user to add new credit account information, membership account information, gift certificate information and the like. Such information may also be removed.

Additionally, the master menu 124 allows the operator to set limits on purchases and other transactions 128. This option allows the user to limit the amount that may be charged to a particular account. These limits may be absolute, by the day, or by the week. These limits also allow the user to restrict usage of an account to certain vendors, certain locations, or other criteria.

The master menu 124 also allows the user to select and modify the alerts and notices 130 offered by the electronic wallet. Alerts and notices may be set to notify a user when the limit for a particular account or an overall limit is within a certain amount of being reached. Notices may also be entered to remind the user of certain dates, such as a birthday. Notices may also be entered intended to remind the user of deadlines or other important items.

When any of the options provided by the menu have been used, the electronic menu provides the user with the option 138 of closing the wallet or returning to the menu. If the user is finished manipulating the wallet, it may be closed 140.

A user may also wish to use the invention to simply store credit account information in an electronic medium such that it is only accessible to persons having the correct security information, without concern more maintaining accurate records of the transactions performed. A simplified version of the invention stores information required to conduct a transaction using a credit account, security software only allowing transmission of the information when the correct security information is provided to the electronic medium and transmitting the information preferably by means of a radio frequency, infrared or other electromagnetic signal to a receiver. A receiver could preferably be a point of sale device capable of receiving the electromagnetic signal from the invention. In this manner, the credit account information is never available to persons viewing the transaction, further enhancing the security features and increasing the ease of conducting transactions.

Whereas, the present invention has been described in relation to the drawings attached hereto, it should be understood that other and further modifications, apart from those shown or suggested herein, may be made within the spirit and scope of this invention. The software programmed into the device may operate according to the embodiment shown in FIGS. 5 and 6, or in any number of alternative embodiments that allow a user to store credit account information in the device which may be retrieved in order to conduct a transaction. The device preferably also records a running balance as transactions are conducted and preferably allows a user to set limits for himself or other users in order to regulate the types of transactions allowed according to preset requirements for transaction properties. The device may also use any number of the above listed or similar input and output components. Devices such as touch screens and other devices may serve as both an input and an output component. These and other alternative designs and constructions within the scope of the invention are not intended to be limited by the embodiments disclosed herein.

The invention claimed is:

1. A portable, electrical device for regulating financial transactions comprising:
a power supply;
a data processor;
a data storage medium;
credit account data stored on the data storage medium comprising balances for one or more credit accounts stored on the storage medium;
one or more input components;
one or more output components;
one or more transaction processing programs stored on the data storage medium, executable by the data processor and able to perform a transaction analysis comprising:
i) allowing a user to request a financial transaction to be applied to a selected credit account of the one or more credit accounts, the financial transaction comprising transaction properties including an amount and the selected credit account;
ii) providing credit account data for the financial transaction through at least one of the one or more output components;
iii) recording the transaction properties; and,
iv) recalculating the available balance by subtracting the amount of the transaction from the initial balance of the selected credit account;
v) adjusting the account data for subsequent transactions;
vi) repeating steps i) through v) when requested by the user;
and,
a security program stored on the storage medium and executable by the data processor for regulating access to the one or more transaction processing programs and the storage medium by requiring at least a password to be entered prior to executing the transaction processing program or entering and retrieving data stored in the data storage medium.

2. The portable, electrical device of claim 1 wherein the one or more transaction processing programs is further able to perform creating an account history for each of the one or more credit accounts comprising the initial balance, the available balances calculated during each financial transaction and the financial transactions.

3. The portable, electrical device of claim 1 further comprising a notification program executable by the data processor and providing the one or more alerts when alert criteria are met.

4. The portable, electrical device of claim 1 further comprising a financial analysis program executable by the data processor and able to perform functions including grouping and summing the financial transactions according to at least one of the transaction properties, wherein the transaction properties comprise the date of the transaction, the selected credit account, and the amount of the transaction.

5. The portable, electrical device of claim 1 further comprising an organizing program executable by the data processor and comprising a clock, a calendar and a scheduler.

6. The portable, electrical device of claim 1 further comprising a case.

7. The portable, electrical device of claim 1 wherein the device is has a width less than one and half inches, a height less than six inches and a length less than six inches.

8. The portable, electrical device of claim 1 wherein the one or more output devices are selected from the group consisting of a video screen, a touch screen, an audio output, an electromagnetic transmitter, and a USB port, and wherein the one or more input devices are selected from the group consisting of a magnetic strip reading slot, a video screen, a touch screen, an electromagnetic receiver, a USB port, and a keypad.

9. A portable, electrical device for regulating financial transactions comprising:
a power supply;
a data processor;
a data storage medium;
credit account data for one or more credit accounts stored on the storage medium comprising authorizing criteria and an available balance for each of the one or more credit accounts;
one or more input components;
one or more output components;
at least one transaction processing program executable by the data processor and performing a transaction analysis comprising:
vii) allowing a user to request a transaction to be applied to a selected credit account of the one or more credit accounts, the transaction comprising transaction properties including an amount and the selected credit account;
viii) comparing authorizing criteria for the selected credit account to the transaction properties of the transaction;
ix) approving a financial transaction if the transaction properties meet the authorizing criteria;
x) providing credit account data for the selected credit account if the transaction is approved;
xi) recording the transaction properties;
xii) recalculating the available balance by subtracting the transaction amount from the available balance; and,
xiii) adjusting the authorizing criteria for subsequent transactions;
xiv) repeating steps i) through vi) when requested by the user;
and,
a security program stored on the storage medium and executable by the data processor for regulating access to the at least one transaction processing program and the storage medium by requiring one or more identifiers be entered by means of the one or more input components prior to executing the transaction processing program or entering and retrieving data stored in the data storage medium.

10. The portable, electrical device of claim 9 further comprising a second security program requiring at least a password and allowing a user access only to the transaction processing program.

11. The portable, electrical device of claim 9 wherein the functions performed by the at least one transaction processing program further includes creating an account history for each of the one or more credit accounts comprising the initial balance financial transactions recorded in the storage media.

12. The portable, electrical device of claim 9 further comprising a notification program executable by the data processor and providing the one or more alerts when alert criteria are met.

13. The portable, electrical device of claim 9 further comprising a financial analysis program executable by the data processor and performing functions including grouping and summing the financial transactions recorded by the at least one transaction processing program according to at least one of the transaction properties, wherein the transaction properties comprise the date of the transaction, the credit account to which it is applied, and the amount of the transaction.

14. The portable, electrical device of claim 9 further comprising an organizing program executable by the data processor and comprising a clock, a calendar and a scheduler.

15. The portable, electrical device of claim 9 wherein the device is has a width less than one and half inches, a height less than six inches and a length less than six inches.

16. The portable, electrical device of claim 9 wherein the one or more output devices are selected from the group consisting of a video screen, a touch screen, an audio output, an electromagnetic transmitter, and a USB port, and wherein the one or more input devices are selected from the group consisting of a magnetic strip reading slot, a video screen, a touch screen, an electromagnetic receiver, a USB port, and a keypad.

17. The portable, electrical device of claim 9 wherein the authorizing criteria is one or more of the criteria selected from the group consisting of a maximum allowable expenditures amount, a list of allowable vendors, a list of allowable dates, a list of allowable credit accounts and a list of allowable purchase items.

18. The portable, electrical device of claim 9 wherein the transaction data comprises the date, time, point of purchase, amount, selected credit account and purchase item.

19. A portable, electrical device for regulating financial transactions comprising:
a power supply;
a data processor;
a data storage medium;
credit account data for one or more credit accounts stored on the storage medium comprising authorizing criteria and an initial balance for each of the at least one of credit account stored on the storage medium, wherein the authorizing criteria comprises a maximum allowable expenditures;
input components comprising a magnetic strip reading slot, a USB port, and a keypad;
output components comprising a video screen, an electromagnetic transmitter, and a USB port;
at least one transaction processing program executable by the data processor and performing a transaction analysis comprising:
i) allowing a user to request a financial transaction to be applied to a selected credit account of the one or more credit accounts, the financial transaction comprising transaction properties including an amount and the selected credit account;
ii) comparing authorizing criteria for the selected credit account to the transaction properties of the financial transaction including calculating whether the financial transaction in addition to other recent transactions exceeds the maximum allowable expenditures;
iii) approving a financial transaction if the transaction properties meet the authorizing criteria;
iv) providing credit account data for the selected credit account if the financial transaction is approved;
v) recording the financial transaction properties in the storage media; and,
vi) adjusting the authorizing criteria for analyzing subsequent transactions;
vii) repeating steps i) through vi) when requested by the user;
a notification program executable by the data processor and providing the one or more alerts when alert criteria are met, wherein the alert comprises a textual message and the alert criteria is selected from the group consisting of an available balance of a credit account and an amount of time before a date; and,
a security program stored on the storage medium and executable by the data processor for regulating access to the at least one transaction processing program and the storage medium by requiring one or more identifiers be entered by means of the one or more input components prior to executing the transaction processing program or entering and retrieving data stored in the data storage medium including adjusting the maximum allowable expenditures, the one or more credit accounts and credit account data;
a second security program requiring at least a password and allowing a user access only to the transaction processing program.

20. The portable, electrical device of claim 19 wherein the authorizing criteria comprises maximum allowable expenditures and one or more of the criteria selected from the group consisting of a list of allowable vendors, a list of allowable dates, a list of allowable credit accounts and a list of allowable purchase items.

21. A method for monitoring financial transactions comprising:
storing in a portable, electronic device credit account data including data necessary for conducting a transaction through at least one credit account;
storing in a portable, electronic device authorizing criteria for evaluating transaction data;
entering into the portable, electronic device transaction data for a transaction;
evaluating by using programming executable by a data processor in the portable, electronic device whether the transaction data meets the authorizing criteria;
approving the transaction if the transaction data meets the authorizing criteria;
providing credit account data for the transaction if the transaction is approved;
recording the transaction data for the transactions if it is approved; and,
adjusting the authorizing criteria for analyzing subsequent transactions.

22. The method of claim 20 wherein the transaction data comprises one or more of the group consisting of a time, a date, a selected credit account, an amount, a vendor, and a list of purchase items.

23. The method of claim 20 wherein a first security code is required to alter or enter the authorizing criteria and credit account data and a second security code does not allow alteration of the authorizing criteria or the credit account data but does allow the evaluating of a the providing of credit account data when the transaction is approved.

24. An electronic device comprising:
a data storage device;
a data processor;
credit account information stored on the data storage device;
security software executable by the data processor and authorizing release of the credit account information only upon a user providing correct security information to the data processor;
an electromagnetic signal transmitter capable of transmitting the credit account information through an electromagnetic signal to an electromagnetic receiver.
